(19) United States
(12) Patent Application Publication
(10) Pub. No.: US 2026/0316756 A1
(43) Pub. Date: Oct. 15, 2026

(54) METHOD AND SYSTEM FOR CALCULATING TARGET INTER-VEHICLE DISTANCE OF CRUISE CONTROL MODE

(71) Applicant: HL KLEMOVE CORPORATION, Incheon (KR)

(72) Inventor: Giyeon WON, Incheon (KR)

(73) Assignee: HL KLEMOVE CORPORATION, Incheon (KR)

(21) Appl. No.: 19/337,354

(22) Filed: Sep. 23, 2025

(30) Foreign Application Priority Data
Apr. 11, 2025 (KR) 10-2025-0047151

(51) Int. Cl. B60W 30/16; B60W 40/10

(52) U.S. Cl. CPC B60W 30/162; B60W 40/10; B60W 2554/4042; B60W 2554/802

(57) ABSTRACT

A method for calculating a target inter-vehicle distance of a cruise control mode according to an embodiment of the present disclosure comprises: activating cruise control mode of an ego vehicle; recognizing a front vehicle ahead of the ego vehicle; calculating a target inter-vehicle distance of the cruise control mode based on a speed of the front vehicle; and controlling driving of the ego vehicle according to the calculated target inter-vehicle distance.

### CROSS-REFERENCE TO RELATED APPLICATION

This application claims the benefit of and priority to Korean Patent Application No. 10-2025-0047151 filed on Apr. 11, 2025, the entire disclosures of which are incorporated herein by reference.

### TECHNICAL FIELD

The present disclosure relates to a method and system for calculating the target inter-vehicle distance of cruise control mode. More specifically, the present disclosure relates to a method and system for calculating the target inter-vehicle distance of cruise control mode that can improve the approaching performance to a front vehicle when the ego vehicle is driving in cruise control mode.

### BACKGROUND

In vehicles, a Driver Assistance System provides support to the driver while driving for the driver's convenience.

For example, among driver assistance systems, a cruise control system is a technology that allows a vehicle to drive at a constant speed, and when a front vehicle is detected, the speed of the vehicle is controlled to maintain a constant distance based on the distance to the front vehicle.

Such cruise control is also called Active Cruise Control (ACC), adaptive cruise control, Smart Cruise Control (SCC), Advanced Smart Cruise Control, and Dynamic Radar Cruise Control (DRCC).

However, according to the conventional target inter-vehicle distance calculation method in a cruise control system, if a front vehicle is driving slower than the ego vehicle, sudden deceleration of the ego vehicle to maintain the inter-vehicle distance adversely affects the driver's ride comfort and causes inconvenience to the driver of the rear vehicle due to excessive deceleration.

Furthermore, according to the conventional target inter-vehicle distance calculation method, unnecessary deceleration and subsequent re-acceleration are repeated, increasing fuel consumption and leading to inefficient energy use during acceleration after deceleration, resulting in lower fuel efficiency and increased battery consumption in electric vehicles. In addition, there is a problem that it is difficult to flexibly respond to changes in the speed of the front vehicle in various driving scenarios.

Therefore, there is a need for a method and system for calculating the target inter-vehicle distance of cruise control mode that can prevent excessive deceleration of the ego vehicle when approaching a low-speed front vehicle while driving in cruise control mode and enable smoother driving of the ego vehicle.

### BRIEF SUMMARY

The present disclosure is to solve the problems of the prior art described above, and an object of the present disclosure is to provide a method and system for calculating the target inter-vehicle distance of cruise control mode that sets the target inter-vehicle distance with the front vehicle based on the current speed of the front vehicle in cruise control mode.

However, the technical problems to be achieved by the embodiments of the present disclosure are not limited to the technical problems described above, and other technical problems may exist.

As a technical means for achieving the above technical problem, a method for calculating the target inter-vehicle distance of cruise control mode according to an embodiment of the present disclosure comprises: activating cruise control mode of an ego vehicle; recognizing a front vehicle ahead of the ego vehicle; calculating a target inter-vehicle distance of the cruise control mode based on a speed of the front vehicle; and controlling driving of the ego vehicle according to the calculated target inter-vehicle distance.

Further, the speed of the front vehicle may be lower than a speed of the ego vehicle.

Further, the calculating of the target inter-vehicle distance may comprise; detecting the speed of the ego vehicle; detecting the speed of the front vehicle; and calculating the target inter-vehicle distance based on an equation regarding the speed of the front vehicle and the relative speed between the ego vehicle and the front vehicle.

Further, the activating of the cruise control mode may further comprise setting a predetermined time gap.

Further, the calculating of the target inter-vehicle distance may comprise calculating the target inter-vehicle distance based on a sum of a first value obtained by multiplying the set time gap by the speed of the front vehicle and a second value obtained by multiplying the relative speed between the ego vehicle and the front vehicle by a predetermined parameter value.

Further, the calculating of the target inter-vehicle distance may comprise recalculating the target inter-vehicle distance based on a changed speed of the front vehicle when the speed of the front vehicle has been changed.

Further, the controlling driving of the ego vehicle may comprise controlling the speed and acceleration of the ego vehicle based on the target inter-vehicle distance calculated in the calculating of the target inter-vehicle distance.

Further, if the preceding vehicle has been cut out, a surrounding vehicle located in front of the front vehicle may be set as a target vehicle.

Further, when the target vehicle is set, the target inter-vehicle distance may be calculated based on the set target vehicle.

A system for controlling the target inter-vehicle distance of cruise control mode according to embodiments of the present disclosure comprises: a first sensor configured to recognize a front vehicle ahead of an ego vehicle; a second sensor configured to detect body information of the ego vehicle; and a controller comprising at least one processor configured to control an inter-vehicle distance between the ego vehicle and the front vehicle when the cruise control mode of the ego vehicle is activated, wherein the controller is configured to calculate a target inter-vehicle distance of the cruise control mode based on a speed of the front vehicle by the at least one processor, and control driving of the ego vehicle according to the calculated target inter-vehicle distance.

Further, the first sensor may comprise at least one of a front camera and a front radar, and the second sensor may comprise at least one of a vehicle speed sensor and a vehicle acceleration sensor.

Further, the speed of the front vehicle may be lower than a speed of the ego vehicle.

Further, the at least one processor may be configured to calculate the target inter-vehicle distance based on an equation regarding the speed of the front vehicle and a relative speed between the ego vehicle and the front vehicle detected by the first sensor and the second sensor.

Further, upon activating the cruise control mode of the ego vehicle, a predetermined time gap may be set.

Further, the at least one processor may be configured to calculate the target inter-vehicle distance based on a sum of a first value obtained by multiplying the set time gap by the speed of the front vehicle and a second value obtained by multiplying the relative speed between the ego vehicle and the front vehicle by a predetermined parameter value.

Further, the at least one processor may be configured to recalculate the target inter-vehicle distance based on a changed speed of the front vehicle when the speed of the front vehicle has been changed.

Further, the controller may be configured to control the speed and acceleration of the ego vehicle based on the target inter-vehicle distance calculated by the at least one processor.

Further, the controller may be connected to a driving apparatus configured to control longitudinal driving of the ego vehicle and a braking apparatus configured to control braking of the ego vehicle, and the controller may be configured to control driving of the ego vehicle according to the cruise control mode by controlling at least one of the driving apparatus and the braking apparatus based on the target inter-vehicle distance calculated by the at least one processor.

Further, the controller may be connected to a display apparatus for providing information to a driver of the above vehicle, and the display apparatus may be configured to display information about the target inter-vehicle distance calculated by the at least one processor in real time to provide information about the target inter-vehicle distance to the driver of the ego vehicle.

Meanwhile, in a non-transitory computer-readable recording medium that records a program for executing a method for calculating the target inter-vehicle distance of cruise control mode on a computer according to an embodiment of the present disclosure, the method comprises: activating cruise control mode of an ego vehicle; recognizing a front vehicle ahead of the ego vehicle; calculating a target inter-vehicle distance of the cruise control mode based on a speed of the front vehicle; and controlling driving of the ego vehicle according to the calculated target inter-vehicle distance.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, by setting the target inter-vehicle distance of the cruise control mode based on the current speed of the front vehicle, it is possible to provide a method and system for controlling the target inter-vehicle distance of cruise control mode that suppresses excessive deceleration of the ego vehicle and enables smooth driving when the front vehicle is driving slower than the ego vehicle.

Further, according to the present disclosure, by setting the target inter-vehicle distance of the cruise control mode based on the current speed of the front vehicle, it is possible to provide a method and system for controlling the target inter-vehicle distance of cruise control mode that can save energy consumed during deceleration and acceleration processes, and enable more flexible distance maintenance in various driving situations.

However, the effects obtainable from the present disclosure are not limited to the effects described above, and other effects may exist.

### BRIEF DESCRIPTION OF THE SEVERAL VIEWS OF THE DRAWINGS

FIG. 1 is a control flowchart showing a method for calculating a target inter-vehicle distance of cruise control mode according to an embodiment of the present disclosure.

FIG. 2 is a control flowchart more specifically showing the step of calculating the target inter-vehicle distance in the method for calculating the target inter-vehicle distance of cruise control mode according to the embodiment of the present disclosure.

FIG. 3A is a diagram showing a driving scenario of the method for calculating the target inter-vehicle distance of cruise control mode according to the embodiment of the present disclosure, and FIG. 3B is a diagram showing a driving scenario in case of calculating the target inter-vehicle distance based on a new target vehicle when the front vehicle cuts out.

FIG. 4 is a graph showing the calculated target inter-vehicle distance values over time compared to the prior art in the method for calculating the target inter-vehicle distance of cruise control mode according to the embodiment of the present disclosure.

FIGS. 5A and 5B are graphs respectively showing the change in vehicle speed over time and the change in vehicle acceleration over time in the method for calculating the target inter-vehicle distance of cruise control mode according to the embodiment of the present disclosure.

FIG. 6 is a control configuration diagram schematically showing a configuration of a system for calculating a target inter-vehicle distance of cruise control mode according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for calculating the target inter-vehicle distance of cruise control mode for providing a more improved cruise control mode by calculating an optimal target inter-vehicle distance with a front vehicle driving at a speed lower than an ego vehicle.

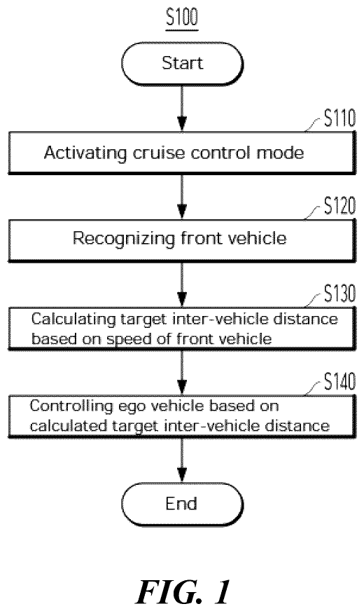

FIG. 1 is a control flowchart showing a method for calculating a target inter-vehicle distance of cruise control mode according to an embodiment of the present disclosure.

Referring to FIG. 1, the method for calculating the target inter-vehicle distance of cruise control mode S100 according to the embodiment of the present disclosure may include a step of activating cruise control mode of an ego vehicle S110 and a step of detecting a front vehicle ahead of the ego vehicle S120.

Here, the cruise control system, as a type of driver assistance system, may refer to a system that allows a vehicle to drive at a constant speed, and when a front vehicle is detected, the speed of the vehicle is controlled to maintain a constant inter-vehicle distance with the front vehicle. The cruise control mode may refer to a vehicle driving mode according to the cruise control system.

Meanwhile, in the cruise control mode, the vehicle drives while maintaining a constant interval (constant separation distance) with the front vehicle. This constant interval may be expressed as a target inter-vehicle distance, or may be expressed as a time such as Headway Time, which is the concept of TTC (Time-To-Collision).

In addition, the detection of the front vehicle may be performed by a front camera or a front radar. However, it is not limited thereto, and for example, the front vehicle may also be detected by other sensors such as LiDAR.

According to the method for calculating the target inter-vehicle distance of cruise control mode according to the embodiment of the present disclosure, a target inter-vehicle distance calculation step of calculating a target inter-vehicle distance based on the speed of the front vehicle S130 may be performed.

Here, the speed of the front vehicle may be sensed by, for example, a front radar installed in the ego vehicle, and the target inter-vehicle distance may be calculated by using the current speed of the front vehicle in real time.

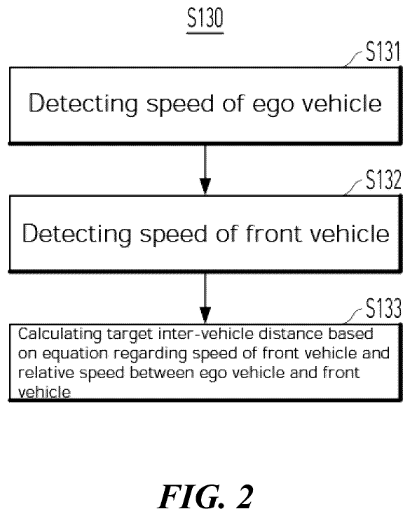

A more specific method for calculating the target inter-vehicle distance will be described with reference to FIG. 2. FIG. 2 is a control flowchart more specifically showing the step of calculating the target inter-vehicle distance in the method for calculating the target inter-vehicle distance of cruise control mode according to the embodiment of the present disclosure.

Referring to FIG. 2, the target inter-vehicle distance calculation step S130 may include: a step of detecting the speed of the ego vehicle S131; a step of detecting the speed of the front vehicle S132; and a step of calculating the target inter-vehicle distance based on an equation regarding the speed of the front vehicle and a relative speed between the ego vehicle and the front vehicle S133.

The speed of the ego vehicle may be detected using a sensor that detects body information, and the speed of the front vehicle may be detected using a sensor that detects surroundings of the ego vehicle, such as a front radar.

Meanwhile, in the target inter-vehicle distance calculation method according to the embodiment of the present disclosure, upon activating the cruise control mode of the ego vehicle, a step of setting a predetermined time gap T may be performed.

The predetermined time gap T is a value that can be set by the driver for inter-vehicle distance setting, and the driver may set the time gap in multiple stages by operating a switch provided at a steering wheel. For example, the time gap T may be set in 4 stages: 1 second, 1.3 seconds, 1.5 seconds, and 2 seconds, but the present disclosure is not limited thereto, and may be set at different time intervals or with a different number of stages as needed.

Specifically, the target inter-vehicle distance calculation step S130 according to the embodiment of the present disclosure may comprise calculating the target inter-vehicle distance of the cruise control mode based on a sum of a value (first value) obtained by multiplying the set time gap by the speed of the front vehicle v_{_lead}, and a value (second value) obtained by multiplying the relative speed between the ego vehicle and the front vehicle (v_{_ego}−v_{_lead}) by a predetermined parameter value k.

Specifically, the target inter-vehicle distance according to the embodiment of the present disclosure may be expressed by the following equation.

d_{_target}=T*v_{_lead}+d_{_min}+k*(v_{_ego}−v_{_lead}) [Equation 1]

Here, T refers to a time gap, and d_{_min} refers to a minimum safe distance. The minimum safe distance may be, for example, within a range of approximately 5-10 m, but is not limited thereto. In addition, k is a parameter value for correcting the inter-vehicle distance according to the speed difference. T, d_{_min}, and k may be preset values.

As shown in Equation 1, according to the method for calculating the target inter-vehicle distance of cruise control mode according to the embodiment of the present disclosure, the target inter-vehicle distance may be calculated based on the speed of the front vehicle v_{_lead}. The term related to the relative speed between the ego vehicle and the front vehicle, k*(v_{_ego}−v_{_lead}), may affect the target inter-vehicle distance calculation until the speed of the ego vehicle and the speed of the front vehicle become the same (v_{_ego}−v_{_lead}=0).

Meanwhile, in the target inter-vehicle distance calculation step S130, if the speed of the front vehicle v_{_lead} is changed, the target inter-vehicle distance may be recalculated based on the changed speed of the front vehicle.

According to the embodiment of the present disclosure as described above, by adjusting the target inter-vehicle distance based on the speed of the front vehicle, when the ego vehicle driving at a higher speed than the front vehicle approaches the front vehicle, unnecessary sudden deceleration is prevented, thereby improving the ride comfort of the occupants and maintaining stable and natural driving.

Referring back to FIG. 1, after calculating the target inter-vehicle distance, a vehicle control step of controlling the ego vehicle according to the calculated target inter-vehicle distance S140 may be performed.

The vehicle control step S140 may control the speed and acceleration of the ego vehicle based on the target inter-vehicle distance calculated in the target inter-vehicle distance calculation step S130.

Specifically, the cruise control of the ego vehicle may be performed to maintain the calculated target inter-vehicle distance, and when the speed of the ego vehicle is greater than the speed of the front vehicle, the speed of the ego vehicle may be controlled (decelerated) to maintain the calculated target inter-vehicle distance. Meanwhile, the target inter-vehicle distance may be updated in real time, and since the speed of the front vehicle may change or the relative speed between the ego vehicle and the front vehicle may change, the target inter-vehicle distance may also be adjusted in real time accordingly.

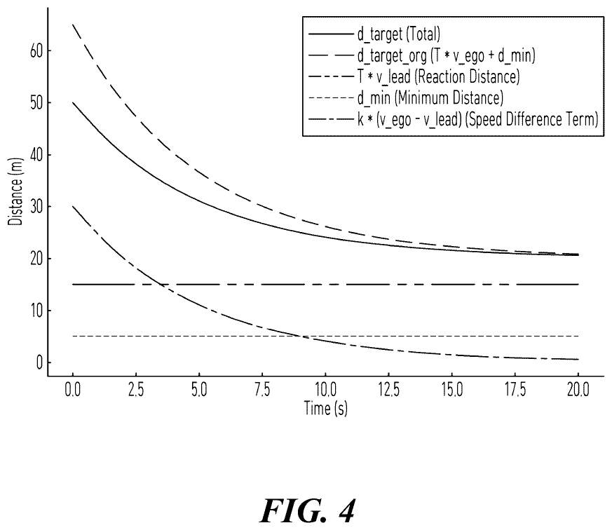

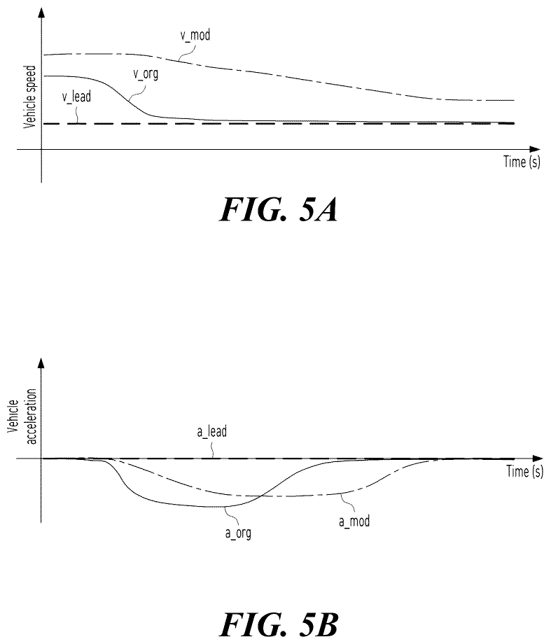

By controlling the driving of the ego vehicle according to the calculated target inter-vehicle distance, sudden deceleration can be prevented and smooth driving can be enabled when the ego vehicle approaches the front vehicle. The change in the target inter-vehicle distance over time and the change in the speed/acceleration of the ego vehicle over time based thereon, calculated according to an embodiment of the present disclosure, will be examined in more detail in the description of FIGS. 4 and 5.

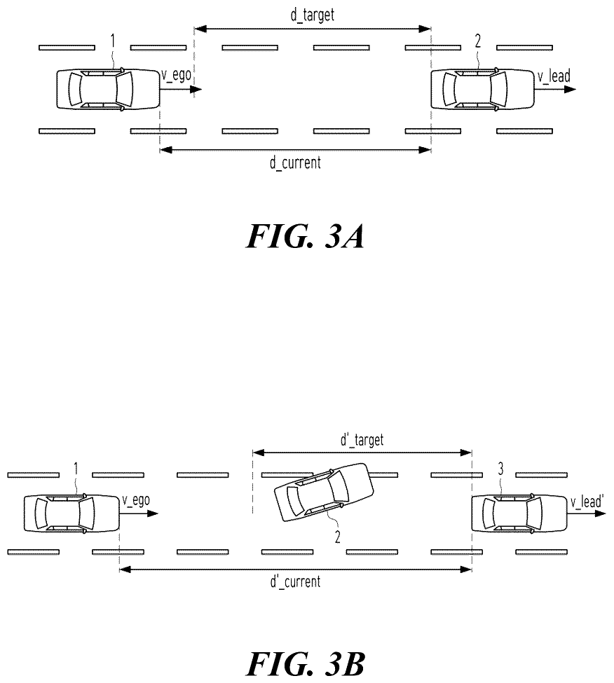

FIG. 3A is a diagram showing a driving scenario of the method for calculating the target inter-vehicle distance of cruise control mode according to the embodiment of the present disclosure, and FIG. 3B is a diagram showing a driving scenario in case of calculating the target inter-vehicle distance based on a new target vehicle when the front vehicle cuts out.

Referring to FIG. 3A, when the ego vehicle 1 is driving in cruise control mode, and a front vehicle 2 is driving at a predetermined distance d_{_current} in front of the ego vehicle 1, the target inter-vehicle distance d_{_target} of cruise control mode may be calculated based on the speed (driving speed) of the front vehicle v_{_lead}.

Here, the driving speed of the front vehicle 2 v_{_lead} may be lower than the driving speed of the ego vehicle 1 v_{_ego}. When the ego vehicle 1 approaches the front vehicle 2 by decelerating to maintain the target inter-vehicle distance d_{_target} with the front vehicle 2, the speed control may be performed by updating the calculated target inter-vehicle distance d_{_target} in real time. By controlling the speed in this way, sudden deceleration of the ego vehicle 1 can be prevented and it is possible to achieve smooth driving.

Referring to FIG. 3B, when the front vehicle 2 of the ego vehicle 1 has been cut out and is excluded from the cruise control target, and a surrounding vehicle 3 located in front of the front vehicle 2 becomes a new target vehicle (the target vehicle is changed from the front vehicle 2 to the surrounding vehicle 3), the target inter-vehicle distance d′_{_target} may be calculated based on the speed of the surrounding vehicle 3 v_{_lead}′ located at a predetermined distance d′_{_current} in front of the ego vehicle 1. The speed and acceleration of the ego vehicle 1 may be controlled according to the thus calculated target inter-vehicle distance d′_{_target}.

That is, according to the method for calculating the target inter-vehicle distance of cruise control mode according to the embodiment of the present disclosure, when the front vehicle of the ego vehicle cuts out, a surrounding vehicle located in front of the front vehicle may be set as a target vehicle, and when the target vehicle is set, the calculation of the target inter-vehicle distance may be performed for the set target vehicle.

FIG. 4 is a graph showing the calculated target inter-vehicle distance values over time compared to the prior art in the method for calculating the target inter-vehicle distance of cruise control mode according to the embodiment of the present disclosure.

In the graph of FIG. 4, when the speed of the front vehicle is lower than the speed of the ego vehicle, the change in the target inter-vehicle distance and each distance term over time is shown until the speed of the ego vehicle v_{_ego} becomes the same as the speed of the front vehicle v_{_lead} due to the deceleration of the ego vehicle (v_{_ego}−v_{_lead}=0).

First, the conventional target inter-vehicle distance calculation method is generally performed based on the speed of the ego vehicle.

For example, the target inter-vehicle distance according to the prior art (conventional technology) may be calculated by the following equation.

d_{_target_org}=T*v_{_ego}+d_{_min} [Equation 2]

The target inter-vehicle distance d_{_target_org} obtained by the above equation may be represented by the graph shown by the bold dotted line in FIG. 4 (assuming that the speed of the ego vehicle and the minimum safe distance are same as in the embodiment of the present disclosure).

Meanwhile, according to the target inter-vehicle distance calculation method according to the embodiment of the present disclosure, the target inter-vehicle distance may be calculated by Equation 1 described above.

Equation 1 may be divided into a term related to the reaction distance of T*v_{_lead}, a term related to the minimum safe distance of d_{_min}, and a term related to the speed difference of k*(v_{_ego}−v_{_lead}). FIG. 4 shows the distance values obtained by each of these terms as graphs changing over time (Reaction Distance term is shown by a dash-double dotted line, Minimum Distance term is shown by a thin dotted line, and Speed Difference term is shown by a dash-single dotted line), and the final target inter-vehicle distance d_{_target} obtained by summing these terms is shown by a solid line.

As can be seen from the graph in FIG. 4, the initial target inter-vehicle distance d_{_target} according to an embodiment of the present disclosure may be set considerably smaller compared to the target inter-vehicle distance d_{_target_org} calculated according to the prior art. This is because in a situation where the speed of the ego vehicle v_{_ego} is significantly higher than the speed of the front vehicle v_{_lead}, the initial target inter-vehicle distance is smaller in case that the target inter-vehicle distance is determined based on the speed term of the front vehicle T*v_{_lead} compared to when it is determined based on the speed term of the ego vehicle T*v_{_ego}.

That is, as in the embodiment of the present disclosure, when the target inter-vehicle distance is set based on the speed of the front vehicle, the initial target inter-vehicle distance becomes smaller when starting the front vehicle following control, so there is no need to suddenly decelerate when the ego vehicle is driving at high speed. Accordingly, the ego vehicle can be gradually decelerated, enabling smoother driving and significantly improving ride comfort.

FIGS. 5A and 5B are graphs respectively showing the change in vehicle speed over time and the change in vehicle acceleration over time in the method for calculating the target inter-vehicle distance of cruise control mode according to the embodiment of the present disclosure.

Referring to FIG. 5A, when the speed of the front vehicle is constant at v_{_lead}, it may be confirmed that the slope (change in speed over time) of the speed of the ego vehicle v_{_mod} according to the target inter-vehicle distance calculation according to the embodiment of the present disclosure is much more gradual at the beginning of control compared to the slope (change in speed over time) of the speed of the ego vehicle v_{_org} according to the conventional target inter-vehicle distance calculation.

In addition, referring to FIG. 5B, when the acceleration of the front vehicle a_{_lead} is 0 (driving at a constant speed), it may be confirmed that the acceleration of the ego vehicle a_{_org} according to the conventional target inter-vehicle distance calculation sharply decreases (has a large value in the negative direction) at the beginning of control (sudden deceleration of the ego vehicle), compared to the acceleration of the ego vehicle a_{_mod} according to the target inter-vehicle distance calculation according to the embodiment of the present disclosure.

As such, according to the method for calculating the target inter-vehicle distance of cruise control mode according to the embodiment of the present disclosure, when performing control following a front vehicle driving slower than the ego vehicle in cruise control mode, sudden deceleration of the ego vehicle can be prevented at the beginning of control, and the driving pattern of the ego vehicle can become more stable and smoother.

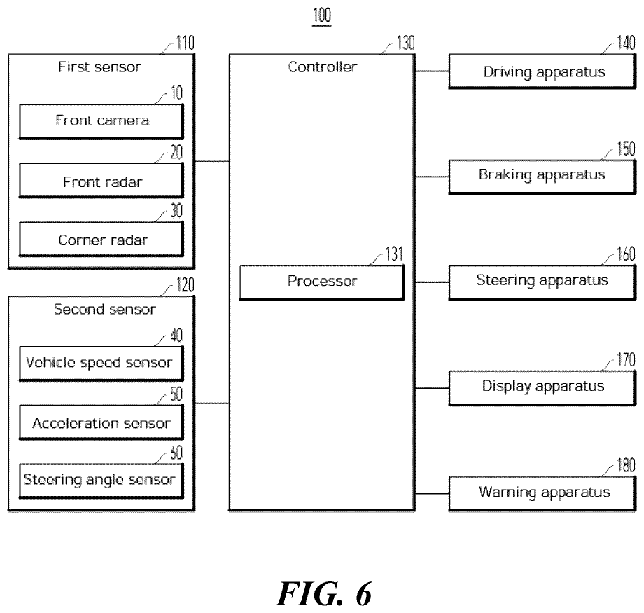

FIG. 6 is a control configuration diagram schematically showing a configuration of a system for calculating a target inter-vehicle distance of cruise control mode according to embodiments of the present disclosure.

Referring to FIG. 6, the system for calculating the target inter-vehicle distance of cruise control mode 100 according to embodiments of the present disclosure comprises: a first sensor 110 configured to recognize a front vehicle of an ego vehicle; a second sensor 120 configured to detect body information of the ego vehicle; and a controller 130 comprising at least one processor configured to control an inter-vehicle distance between the ego vehicle and the front vehicle when the cruise control mode of the ego vehicle is activated.

The controller 130 may be configured to calculate a target inter-vehicle distance of the cruise control mode based on a driving speed of the front vehicle by the at least one processor, and control driving of the ego vehicle according to the calculated target inter-vehicle distance.

The first sensor 110 configured to recognize a front vehicle of the ego vehicle may include at least one of a front camera and a front radar. Here, the front camera may be an image sensor for acquiring image data, and the front radar may be a radar sensor for acquiring distance information and speed information. However, the present disclosure is not limited thereto, and various sensors such as LiDAR (Light Detection and Ranging) that can recognize the surroundings may be included.

The second sensor 120 configured to detect body information of the ego vehicle may include at least one of a vehicle speed sensor and a vehicle acceleration sensor. Here, the vehicle speed sensor may be a sensor that detects the speed of the ego vehicle, and the vehicle acceleration sensor may be a sensor that detects the acceleration of the ego vehicle. However, the present disclosure is not limited thereto, and various sensors that can detect vehicle body information may be included.

At least one processor 131 included in the controller 130 may calculate the target inter-vehicle distance based on an equation regarding the speed of the front vehicle and the relative speed between the ego vehicle and the front vehicle, detected by the first sensor 110 and the second sensor 120.

In addition, at least one processor 131 may calculate the target inter-vehicle distance based on a sum of a first value obtained by multiplying the set time gap by the speed of the front vehicle and a second value obtained by multiplying a relative speed between the ego vehicle and the front vehicle by a predetermined parameter value.

Additionally, at least one processor 131 may recalculate the target inter-vehicle distance based on the changed speed of the front vehicle when the speed of the front vehicle has changed.

In addition, the controller 130 may control the speed and acceleration of the ego vehicle based on the target inter-vehicle distance calculated by at least one processor 131.

In addition, the controller 130 may be connected to a driving apparatus 140 configured to control longitudinal driving of the ego vehicle and a braking apparatus 150 configured to control braking of the ego vehicle. In addition, the controller 130 may also be connected to a steering apparatus 160 configured to control lateral driving of the ego vehicle.

Accordingly, the controller 130 may control driving of the ego vehicle according to the cruise control mode by controlling at least one of the driving apparatus 140 and the braking apparatus 150 based on the target inter-vehicle distance calculated by at least one processor 131.

Additionally, the controller 130 may be connected to a display apparatus 170 configured to provide information to the driver of the ego vehicle.

Accordingly, the display apparatus 170 may display information about the target inter-vehicle distance calculated by at least one processor 131 included in the controller 130 in real time to provide information about the target inter-vehicle distance to the driver of the ego vehicle.

Additionally, the controller 130 may be connected to a warning apparatus 180 configured to issue a warning or provide an alarm to the driver of the ego vehicle.

Accordingly, the warning apparatus 180 may provide an alarm (visual alarm, auditory alarm, or haptic alarm) to the driver when the target inter-vehicle distance has been changed or the cruise control target vehicle has been changed during cruise control mode driving.

Regarding the method for calculating a target inter-vehicle distance of cruise control mode according to the embodiment of the present disclosure performed by the controller 130, since it has been described in detail previously, a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiments of the present disclosure as described above, it is possible to provide a method and system for calculating a target inter-vehicle distance in cruise control mode that can suppress excessive deceleration of the vehicle and enable smooth driving when the ego vehicle approaches a front vehicle driving at a slower speed than the ego vehicle while driving in cruise control mode.

Further, according to the method and system for calculating the target inter-vehicle distance in cruise control mode according to the embodiments of the present disclosure, the system can be adjusted to ensure that the ego vehicle approaches the target inter-vehicle distance to the front vehicle at a constant and smooth speed while maintaining a consistent speed difference with the front vehicle until the approach is complete, enabling the overall driving to be performed consistently.

Furthermore, according to the method and system for calculating the target inter-vehicle distance in cruise control mode according to the embodiments of the present disclosure, since the inter-vehicle distance can be set according to the change in the speed of the front vehicle, it is possible to maintain a more flexible distance in various driving situations, and also it is possible to optimize the distance to the front vehicle and optimize the speed of the ego vehicle in complex driving environments such as highways.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
2: Front vehicle
3: Surrounding vehicle
10: Front camera
20: Front radar
30: Corner radar
40: Vehicle speed sensor
50: Acceleration sensor
60: Steering angle sensor
100: System for calculating target inter-vehicle distance of cruise control mode
110: First sensor
120: Second sensor
130: Controller
131: Processor
140: Driving apparatus
150: Braking apparatus
160: Steering apparatus
170: Display apparatus
180: Warning apparatus

1. A method for calculating a target inter-vehicle distance of cruise control mode, comprising:
activating cruise control mode of an ego vehicle;
recognizing a front vehicle ahead of the ego vehicle;
calculating a target inter-vehicle distance of the cruise control mode based on a speed of the front vehicle; and
controlling driving of the ego vehicle according to the calculated target inter-vehicle distance.

2. The method of claim 1, wherein the speed of the front vehicle is lower than a speed of the ego vehicle.

3. The method of claim 2, wherein the calculating of the target inter-vehicle distance comprises; detecting the speed of the ego vehicle; detecting the speed of the front vehicle; and
calculating the target inter-vehicle distance based on an equation regarding the speed of the front vehicle and the relative speed between the ego vehicle and the front vehicle.

4. The method of claim 3, wherein the activating of the cruise control mode further comprises setting a predetermined time gap.

5. The method of claim 4, wherein the calculating of the target inter-vehicle distance comprises calculating the target inter-vehicle distance based on a sum of a first value obtained by multiplying the set time gap by the speed of the front vehicle and a second value obtained by multiplying the relative speed between the ego vehicle and the front vehicle by a predetermined parameter value.

6. The method of claim 5, wherein the calculating of the target inter-vehicle distance comprises recalculating the target inter-vehicle distance based on a changed speed of the front vehicle when the speed of the front vehicle has been changed.

7. The method of claim 1, wherein the controlling driving of the ego vehicle comprises controlling the speed and acceleration of the ego vehicle based on the target inter-vehicle distance calculated in the calculating of the target inter-vehicle distance.

8. The method of claim 7, wherein if the preceding vehicle has been cut out, a surrounding vehicle located in front of the front vehicle is set as a target vehicle.

9. The method of claim 8, wherein when the target vehicle is set, the target inter-vehicle distance is calculated based on the set target vehicle.

10. A system for calculating a target inter-vehicle distance of cruise control mode, comprising:
a first sensor configured to recognize a front vehicle ahead of an ego vehicle;
a second sensor configured to detect body information of the ego vehicle; and
a controller comprising at least one processor configured to control an inter-vehicle distance between the ego vehicle and the front vehicle when the cruise control mode of the ego vehicle is activated,
wherein the controller is configured to calculate a target inter-vehicle distance of the cruise control mode based on a speed of the front vehicle by the at least one processor, and control driving of the ego vehicle according to the calculated target inter-vehicle distance.

11. The system of claim 10, wherein the first sensor comprises at least one of a front camera and a front radar, and the second sensor comprises at least one of a vehicle speed sensor and a vehicle acceleration sensor.

12. The system of claim 11, wherein the speed of the front vehicle is lower than a speed of the ego vehicle.

13. The system of claim 12, wherein the at least one processor is configured to calculate the target inter-vehicle distance based on an equation regarding the speed of the front vehicle and a relative speed between the ego vehicle and the front vehicle detected by the first sensor and the second sensor.

14. The system of claim 13, wherein upon activating the cruise control mode of the ego vehicle, a predetermined time gap is set.

15. The system of claim 14, wherein the at least one processor is configured to calculate the target inter-vehicle distance based on a sum of a first value obtained by multiplying the set time gap by the speed of the front vehicle and a second value obtained by multiplying the relative speed between the ego vehicle and the front vehicle by a predetermined parameter value.

16. The system of claim 15, wherein the at least one processor is configured to recalculate the target inter-vehicle distance based on a changed speed of the front vehicle when the speed of the front vehicle has been changed.

17. The system of claim 16, wherein the controller is configured to control the speed and acceleration of the ego vehicle based on the target inter-vehicle distance calculated by the at least one processor.

18. The system of claim 10, wherein the controller is connected to a driving apparatus configured to control longitudinal driving of the ego vehicle and a braking apparatus configured to control braking of the ego vehicle, and
wherein the controller is configured to control driving of the ego vehicle according to the cruise control mode by controlling at least one of the driving apparatus and the braking apparatus based on the target inter-vehicle distance calculated by the at least one processor.

19. The system of claim 18, wherein the controller is connected to a display apparatus for providing information to a driver of the above vehicle, and
wherein the display apparatus is configured to display information about the target inter-vehicle distance calculated by the at least one processor in real time to provide information about the target inter-vehicle distance to the driver of the ego vehicle.

20. A non-transitory computer-readable recording medium that records a program for executing a method for calculating a target inter-vehicle distance of cruise control mode on a computer, the method comprising:
activating cruise control mode of an ego vehicle;
recognizing a front vehicle ahead of the ego vehicle;
calculating a target inter-vehicle distance of the cruise control mode based on a speed of the front vehicle; and
controlling driving of the ego vehicle according to the calculated target inter-vehicle distance.
